(19) United States
(12) Patent Application Publication
(10) Pub. No.: US 2018/0314811 A1
(43) Pub. Date: Nov. 1, 2018

(54) ELECTRONIC DEVICES AND METHODS FOR CONTROLLING USER INTERFACE

(71) Applicant: Quanta Computer Inc., Taoyuan City (TW)

(72) Inventor: Li-Te HUNG, Taoyuan City (TW)

(21) Appl. No.: 15/675,934

(22) Filed: Aug. 14, 2017

(30) Foreign Application Priority Data
Apr. 28, 2017 (TW) 106114240

(51) Int. Cl. G06F 21/32; G06F 21/57; G06K 9/00

(52) U.S. Cl. CPC G06F 21/32; G06K 9/00288; G06F 21/572

(57) ABSTRACT

An electronic device includes a processor, an embedded controller, a camera, a RAM and a storage device. The processor is configured to transmit a shot signal according to a start signal, and receive login information to execute an operating system. The embedded controller is configured to count a number of the received start signals. The camera is configured to capture a user image according to the shot signal before the processor logs in to the operating system. The RAM is configured to store the user image. The storage device is configured to store the user image after the processor logs in to the operating system.

### CROSS REFERENCE TO RELATED APPLICATIONS

This Application claims priority of Taiwan Patent Application No. 106114240, filed on Apr. 28, 2017, the entirety of which is incorporated by reference herein.

### BACKGROUND OF THE INVENTION

### Field of the Invention

The present invention relates to an electronic device, and more particularly to an electronic device that automatically captures an image of the user when the electronic device is turned on.

### Description of the Related Art

With the advancements being made in technology, electronic devices are widely used in daily life. As the functions supported by electronic devices have increased in number, the amount of personal information stored in such electronic devices has also increased. So how to effectively protect the security of the user's information has become an important issue. The most common network attacks can be prevented by anti-virus software, but the peep or invasion cannot be effectively stopped. Therefore, how to effectively monitor logins and monitor access to the electronic device is a problem that needs to be solved immediately.

### BRIEF SUMMARY OF INVENTION

To solve the problems described above, an embodiment of the present invention provides an electronic device, including a processor, an embedded controller, a camera, a RAM, and a storage device. The processor transmits a shot signal according to a start signal, and receives login information to execute an operating system. The embedded controller counts a number of the received start signals. The camera captures a user image according to the shot signal before the processor logs in to the operating system. The RAM stores the user image. The storage device stores the user image after the processor logs in to the operating system.

Additional features and advantages of the disclosure will be set forth in the description which follows, and, in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF DRAWINGS

The invention can be more fully understood by reading the subsequent detailed description and examples with references made to the accompanying drawings, wherein:

FIG. 1 is a block diagram of an electronic device in accordance with an embodiment of the present invention.

FIG. 2 is a flow chart of a method for monitoring logins to the electronic device in accordance with an embodiment of the present invention.

### DETAILED DESCRIPTION OF INVENTION

Further areas to which the present electronic devices and methods for monitoring logins to an electronic device can be applied will become apparent from the detailed description provided herein. It should be understood that the detailed description and specific examples, while indicating exemplary embodiments of electronic devices and methods for monitoring logins to an electronic device, are intended for the purposes of illustration only and are not intended to limit the scope of the invention.

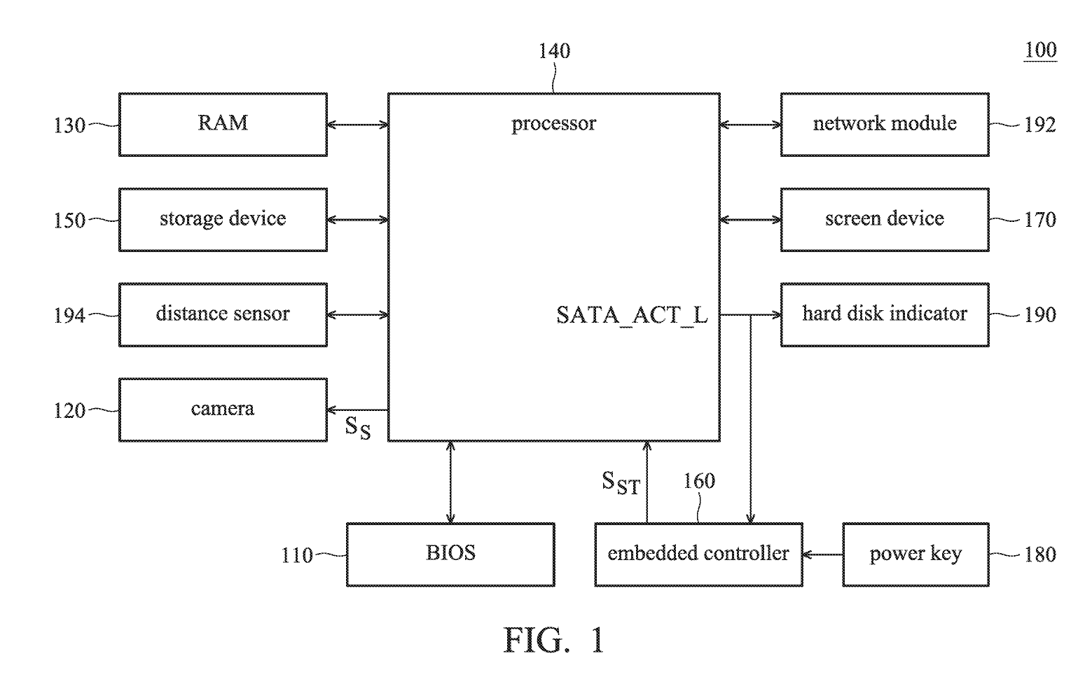

FIG. 1 is a block diagram of an electronic device in accordance with an embodiment of the present invention. The electronic device 100 includes a basic input/output system (referred as “BIOS” hereinafter) 110, a camera 120, a random access memory (referred as “RAM” hereinafter) 130, a processor 140, a storage device 150, an embedded controller (EC) 160, a screen device 170, a power key 180 and so on, but it is not limited thereto.

The electronic device 100 can be, for example, a desktop computer or a notebook. The screen device 170 is used to display information such as graphics or text, which may have a touch function so that the user can operate the electronic device with the finger directly. The BIOS 110 may provide a user interface on the screen device 170 for setting the parameters of the system configuration or the startup settings of the system by the user. The camera 120 is faced toward the user for capturing an image of the user. In a particular embodiment, the camera 120 is provided on the front side of the screen device 170. The RAM 130 is used to store the user image captured by the camera 120, and execute the program of the electronic device 100. The processor 140 can be a central processing unit (CPU) or a system on chip (SOC) used for logging in and for executing the operating system installed in the storage device 150, as well as for executing instructions to achieve a specific function. The storage device 150 can be a hard disk (HDD), a solid state drive (SSD), or an eMMC embedded memory for storing the data and the user image accessible by the processor 140.

At the beginning of the shutdown state or initial state, when the user presses the power key 180, the embedded controller 160 detects that the user has pressed the power key, and outputs a start signal S_{ST} corresponding to the power-on to notify the processor 140. After the processor 140 receives the start signal S_{ST}, the processor 140 accesses the program stored in the BIOS 110 first, and then executes the program to initialize and test the hardware components of the electronic device 100. Then, after initializing the camera 120, the processor 140 outputs a shot signal S_{S} to control the camera 120 to capture an image or video of the user (e.g., by taking a picture or recording a video), and storing the user image (or the video, the same below) to the RAM 130. However, because the RAM 130 will lose the data stored therein after powering off, the user image stored in the RAM 130 must be moved to the storage device 150 to avoid the user image being deleted.

In a particular embodiment, the camera indicator can be turned off (not shown) while the camera 120 is operating to capture an image of the user.

According to an embodiment of the present disclosure, when the user successfully logs in to the default operating system of the electronic device 100 (such as by logging in to the operating system by entering a user account and password, or the like), the user image can be moved (or copied) from the RAM 130 to the storage device 150. For example, when the user enters the correct login information and starts to execute various applications, the processor 140 moves the user image stored in the RAM 130 to the storage device 150.

After the processor 140 moves the user image to the storage device 150, the processor 140 may further determine whether the user is the owner (or authorized user) of the electronic device 100 through a particular application. For example, the owner (or authorized user) may store an image of the owner or authorized user in the storage device 150 in advance, and the captured user's image can be identified, compared or recognized with the pre-stored image of the owner (or authorized user) to determine whether the user is the owner (or an authorized user). When the determination result is that the user is the owner (or an authorized user), the captured user's image can be selectively deleted for saving the storage space of the storage device 150. On the other hand, when the determination result is that the user is not the owner (or is an unauthorized user), the owner can be notified by message.

In a particular embodiment, the electronic device 100 further includes a network module 192, when the user logs in to the operating system, the processor 140 can selectively uploads the captured user's image through the Internet, a local area network, or another wired or wireless transmission technology to a remote server or a cloud drive to save the user image.

During the login process, if the incorrect user account or password is input, the user may feel guilty and then the user may try to press and hold the power key 180 for more than a predetermined time (such as 4 seconds) to enable a forced shutdown of the electronic device 100. To avoid such a situation, which may lead to that the user image cannot be captured or saved, the processor 140 will be immediately notified to move (or save) the captured image of the user from the RAM 130 to the storage device 150 when the embedded controller 160 receives the forced shutdown instruction.

In a particular embodiment, the embedded controller 160 can further detect a specific pin on the processor 140 (such as SATA_ACT_L pin which indicates whether the storage device 150 is in operation or not) to determine whether the storage procedure (i.e. from the RAM 130 to the storage device 150) of the captured image of the user is complete. When the embedded controller 160 determines that the storage procedure is complete, the embedded controller 160 will perform a forced shutdown. As such, even if the user enables a forced shutdown, the captured image of the user will still be stored in the storage device 150.

In a particular embodiment, if the incorrect user account and password is entered a certain number of times, such as three times, (because the user is not the owner or an authorized user) the embedded controller 160 will immediately notify the processor 140 to move (or copy) the captured image of the user stored in the RAM 130 to the storage device 150 regardless of whether the user presses the power key 180 to force a shutdown.

In addition, it is possible to turn off a hard disk indicator 190 of the electronic device 100 by disabling a specific pin (such as SATA_ACT_L) on the processor 140 while the storage procedure is processing.

In a particular embodiment, for determining whether the user wants to press the power key 180 for the forced shutdown, the processor 140 can determine whether there is an object (finger) is approaching by deposing a distance sensor 194 near the power key 180, or it can determine whether the user wants to perform a forced shutdown according to the image captured by the camera 120.

In the shutdown state or initial state as described above, after the user presses the power key 180 and before the user enters the login screen of the default operating system, it is possible for an unauthorized user to find that the camera 120 is capturing an image, and when the unauthorized user feels guilty, he/she may enters into the BIOS 110 to modify the startup setting for completing the boot operation without performing the login operation on the default operating system. For example, the user is able to enter the operating system of the electronic device 100 through an external storage device (such as flash memory) by modifying the startup settings. To prevent such a situation, the BIOS 110 will notify the processor 140 to move (or copy) the user image stored in the RAM 130 to the storage device 150 while it detects the modification of the startup settings. As such, even if the user modifies the startup settings, the user image is still stored in the storage device 150.

In a particular embodiment, modifying the startup settings means, for example, modifying the BIOS parameter-setting instructions.

In a particular embodiment, the internal memory of the processor 140 can also record the number of capturing times of the captured images of the user (one time corresponds to one image, which means the number of the captured images of the user can also be obtained), and obtain the number of times that the electronic device 100 has booted up can be obtained from the memory of the embedded controller 160 (i.e., counting the number of start signals S_{ST}). Further, the processor 140 determines whether the number of captured images (or the number of shooting times) of the user in the storage device 150 is the same as the number of boot-ups. In a particular embodiment, the internal memory of the processor 140 can be, for example, a CMOS RAM of an RTC module.

According to the process of capturing an image of the user while booting the electronic devices 100 as described above, the number of captured images of the user must be the same as the number of boot-ups. Thus, the processor 140 can determine whether the stored image of the user has been deliberately deleted by another person according to the determination result to find out what the security problems of the electronic device 100 are.

According to another embodiment of the present disclosure, when the processor 140 determines that the image captured by the camera 120 does not include the picture of the owner (i.e. the owner is not shown in the captured image), it then notifies the embedded controller 160 to execute the forced shutdown instruction. The processor 140 can further disable the start signal S_{ST} through a calendar function in the embedded controller 160, for example, by setting that the electronic device 100 could be booted up after one day, to avoid theft of the data in the electronic device 100.

In addition, to prevent the processor 140 from making an incorrect determination, when the camera 120 does not capture an image of the user the first time, for example if the processor 140 finds that the user does not blink during the shooting process, the processor 140 determines that the user image has not been captured, and then the processor 140 generates a notification through the screen device 170 (such as flashing the screen backlight for 10 seconds). After that, the camera once again captures an image of the user. However, when the processor 140 determines that the camera 120 has still failed to capture an image of the user a second time, it then notifies the embedded controller 160 to execute the forced shutdown instruction.

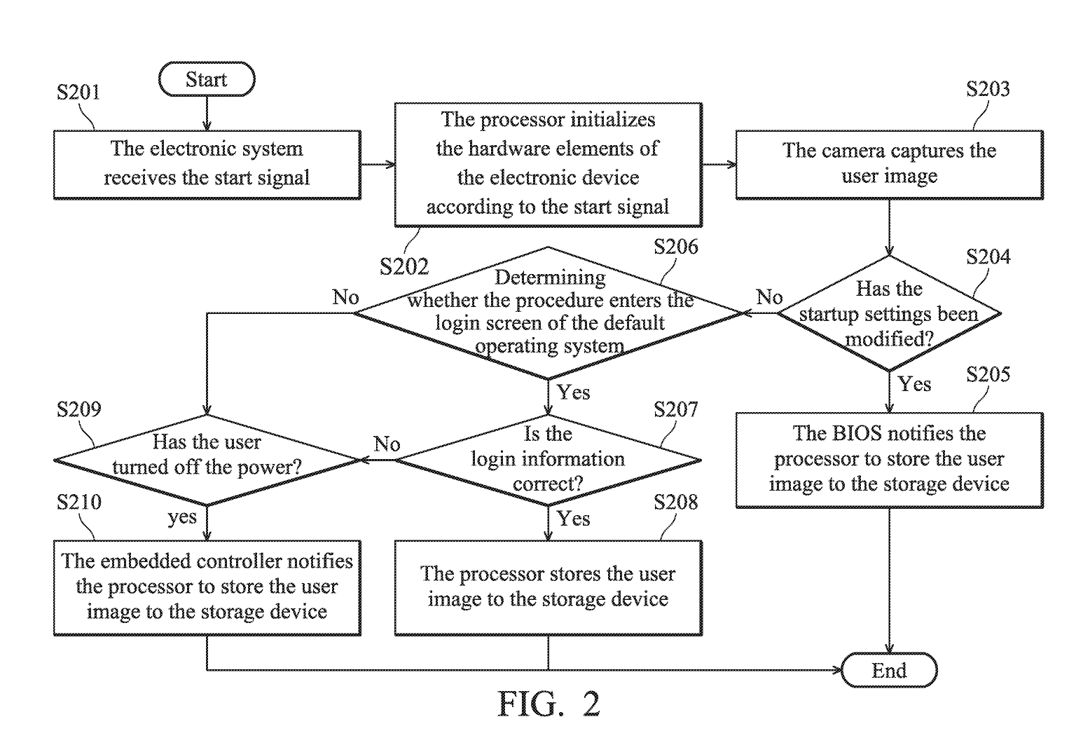

FIG. 2 is a flow chart of a method for monitoring the logins to an electronic device in accordance with an embodiment of the present invention. In step S201, the electronic system 100 receives the start signal S_{ST}. In step S202, the processor 140 initializes the hardware elements of the electronic device 100 according to the start signal S_{ST}. After the processor 140 completes initialization of the hardware elements, the method proceeds to step S203, and the processor 140 outputs the shot signal S_{S} to control the camera 120 to capture the user image by capturing the image or recording the video, and stores the user image to RAM 130.

Next, in step S204, it is determined whether the user has modified the startup settings (modifying the instructions). This step is used to prevents a non-owner or an unauthorized user from accessing the electronic device 100 by modifying the starting program of the BIOS 110 directly rather than going through the default login procedure of the operating system, such as by modifying the startup settings to execute the starting program from the external storage devices (such as flash memory).

When it is determined that the user has entered into the BIOS 110 to modify the startup settings, the method proceeds to step S205, and the BIOS 110 notifies the processor 140 to move (or copy) the captured user image from the RAM 130 to the storage device 150. On the other hand, if the user does not modify the startup settings, the method proceeds to step S206.

In step S206, the BIOS 110 determines whether the procedure enters the login screen of the default operating system. If so, the method proceeds to step S207, and the processor 140 receives the login information (account and password) of the user, and determines whether the login information is correct. When the processor 140 determines that the login information entered by the user is correct, the method proceeds to step S208, and the processor 140 moves (or copies) the user image stored in the RAM 130 to the storage device 150.

On the other hand, when the processor 140 determines that the user has failed to log in to the operating system (that is, the user has entered incorrect login information), the method proceeds to step S209, and the processor 140 determines whether the user has turned off the power. For example, when the processor 140 determines that the user wants to perform a forced shutdown according to the distance sensor 194 disposed near the power key 180 or the image captured by the camera 120, or the embedded controller 160 receives the forced shutdown instruction, the method proceeds to step S210, and the embedded controller 160 notifies the processor 140 to move (or copy) the user image stored in the RAM 130 to the storage device 150 and turn off the power after confirming that the captured image of the user has been stored in the storage device 150. This prevents a non-owner or an unauthorized user from turning off the electronic device 100 after feeling guilty while entering incorrect login information. On the other hand, when the user does not perform a forced shutdown, the method returns to step S207, and the procedure re-enters the interface for inputting the login information. This means that the user may only accidentally enter the incorrect login information, thereby allowing the user to execute the login procedure again.

In a particular embodiment, in step S207, when the processor 140 determines that the user fails to log in to the operating system (i.e., the user enters the incorrect login information) more than a predetermined number of times, the method proceeds directly to step S210, the embedded controller 160 notifies the processor 140 to move (or copy) the captured image of the user stored in the RAM 130 to the storage device 150, and turns off the power after confirming that the user image has been stored in the storage device 150.

Please return to step S206. When the BIOS 110 determines that the procedure does not enter the login screen of the default operating system, the method proceeds to step S209, determining whether the user turn off the power. If so, the method proceeds to step S210, and the embedded controller 160 notifies the processor 140 to move (or copy) the user image stored in the RAM 130 to the storage device 150, and turns off the power after confirming that the user image has been stored in the storage device 150.

As described above, according to the electronic device of the present invention, after the hardware elements of the electronic device are initialized, the image of the current user is immediately captured by the camera, and the captured image of the user will be saved to the hard disk before the electronic device is disabled. Thus, when the data in the electronic device is stolen or someone attempts to access the data in the electronic device, the owner of the electronic device can identify the user who attempted to steal the data according to the captured image stored in the hard disk, thereby improving the protection of the data in the electronic device.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. An electronic device, comprising:
a processor, receiving a start signal, transmitting a shot signal according to the start signal, and receiving login information to execute an operating system;
an embedded controller, accumulating a number of the received start signals;
a camera, capturing a user image according to the shot signal before the processor logs in to the operating system;
a RAM, storing the user image; and
a storage device, storing the user image after the processor logs in to the operating system.

2. The electronic device as claimed in claim 1, further comprising:
a BIOS, notifying the processor to store the user image in the storage device when the BIOS receives a modify instruction.

3. The electronic device as claimed in claim 1, wherein when the camera captures the user image, the camera indicator lamp is turned off.

4. The electronic device as claimed in claim 1, wherein the electronic device further comprises a network module, and the processor uploads the user image to a remote server through the network module.

5. The electronic device as claimed in claim 1, wherein the storage device stores an owner image, and the processor compares the user image and the owner image.

6. The electronic device as claimed in claim 1, wherein the processor determines whether the user image is deleted according to the number of the received start signals and a number of the user images.

7. The electronic device as claimed in claim 1, wherein the embedded controller notifies the processor to move the user image from the RAM to the storage device if the received login information is incorrect and the times of entering the incorrect login information is up to a certain number.

8. The electronic device as claimed in claim 7, wherein the electronic device further comprises a hard disk indicator lamp, and when the processor stores the user image in the storage device, the disk indicator lamp is turned off.

9. The electronic device as claimed in claim 1, wherein the embedded controller notifies the processor to move the user image from the RAM to the storage device when the received login information is incorrect and the embedded controller receives a forced shutdown instruction.

10. The electronic device as claimed in claim 9, wherein the processor determines whether or not the user wants to generate the forced shutdown instruction according to a distance sensor or the camera.
